(19) United States
(12) Patent Application Publication
(10) Pub. No.: US 2021/0054664 A1
(43) Pub. Date: Feb. 25, 2021

(54) SECURITY TAG ASSEMBLY

(71) Applicant: Sekura Global IP LLP, Colchester (GB)

(72) Inventor: Russell NAPTHINE, Colchester (GB)

(73) Assignee: Sekura Global IP LLP, Colchester (GB)

(21) Appl. No.: 16/982,853

(22) PCT Filed: Mar. 21, 2019
(86) PCT No.: PCT/GB2019/050810

§ 371 Date: Sep. 21, 2020

(30) Foreign Application Priority Data
Mar. 22, 2018 (GB) 1804639.1

(51) Int. Cl. E05B 73/00

(52) U.S. Cl. CPC E05B 73/0023

(57) ABSTRACT

The present invention relates to a security assembly, a protective enclosure and a method of protecting an item in a retail environment. An assembly comprises a security tag including a latch mechanism and attachment means, the attachment means being arranged to attach the security tag to an item and a part of the attachment means being releasably engageable with the latch mechanism; and a protective enclosure comprising retaining means arranged to engage a part of the security tag in order to lock the protective enclosure to the security tag and an internal space for receiving at least a part of the item, and wherein, in a locked configuration, the protective enclosure at least partially encloses the item and inhibits access to the item, and wherein disengagement of the attachment means from the latch mechanism simultaneously permits release of the security tag from the item and permits release of the protective enclosure from the security tag.

### FIELD OF THE INVENTION

The present invention relates to security tags and security assemblies including a security tag and a method of providing a security assembly for an item. In particular, the present invention relates to a security assembly including an electronic article surveillance (EAS) tag and a protective enclosure and a method of protecting an item in a retail environment.

### BACKGROUND TO THE INVENTION

A number of electronic article surveillance (EAS) systems are well known and are used in areas such as retail stores to deter or prevent the theft of articles or items of merchandise from the area.

EAS systems include an EAS tag or sensor that is attached to the article, an EAS antenna or detector that it typically positioned at or near an exit of the area, and a detacher or deactivator for removing or deactivating the EAS tag when the article is purchased or is otherwise being removed from the area permissibly or legally.

An EAS system may include one or more technologies selected from magnetic (EM) systems, acousto-magnetic (AM) systems and radio-frequency (RF) systems. Each of these systems have advantages and disadvantages regarding cost, reliability, ease of detection and size.

One known EAS tag is commonly referred to as a hard tag and includes an acousto-magnetic sensor in a hard, or semi-rigid, plastic body. Such hard tags are typically physically or mechanically attached to an article by means of a pin, cable or lanyard. When the article is purchased, the tag is detached from the article by a detacher located at the point of sale.

If the tag is not removed and the article is removed from an area, such as a retail store, the sensor in the tag will emit a signal that is detected by the antenna that is located near the exit of the area. The antenna will typically emit an audible alarm to alert security personnel that an item is being removed impermissibly or illegally, with the tag still attached to the article.

One disadvantage of known hard tags is that they can be broken by applying a suitable force to the plastic body or housing. Breaking a tag in this way allows the EAS sensor to be removed, even if the rest of the tag remains attached to the article. This allows the article to be removed from the retail store without triggering the alarm. Alternatively, the packaging of the item is destroyed or tampered with to enable the security tag to be removed from the item which would prevent detection of the unauthorised removal of the item from the surveillance area.

It is an object of the present invention to provide an improved security tag assembly that overcomes at least one problem associated with the prior art whether referred to herein or otherwise.

### SUMMARY OF THE INVENTION

According to a first aspect of the present invention there is provided an assembly comprising:
a security tag including a latch mechanism and attachment means, the attachment means being arranged to attach the security tag to an item and wherein a part of the attachment means is releasably engageable with the latch mechanism; and
a protective enclosure comprising retaining means arranged to engage a part of the security tag in order to lock the protective enclosure to the security tag and an internal space for receiving at least a part of said item,
wherein, in a locked configuration, the protective enclosure at least partially encloses said item and inhibits access to said item, and wherein disengagement of the attachment means from the latch mechanism simultaneously permits release of the security tag from said item and permits release of the protective enclosure from the security tag.

Preferably disengagement of the attachment means from the latch mechanism unlocks (releases/disengages) the security tag from the item and preferably (simultaneously) unlocks (releases/disengages) the protective enclosure from the security tag.

Preferably the retaining means comprises a first retaining member and a second retaining member. The first retaining member and the second retaining member may be opposed and spaced apart. The first retaining member and the second retaining member may be urged (biased) towards each other. The first retaining member and the second retaining member may enable lateral sides of a security tag to slidably move therebetween as the security tag moves from an unlocked position to the locked position. Preferably the first retaining member and the second retaining member are urged apart by the lateral sides of the security tag as the security tag moves towards the locked position. Preferably in the locked position the retaining members cannot be moved apart by relative movement of (the lateral sides of) the security tag. Preferably each retaining member comprises an (angled) guide surface which causes the retaining members to move apart as the security tag moves towards the locked position. Preferably each retaining member comprises a locking surface which prevents the relative movement of the security tag from being able to move the retaining members apart whilst the security tag is in the locked position.

The security tag may provide a first locking recess for the first retaining member and a second locking recess for the second retaining member. The first locking recess may be provided on a first lateral side of the security tag and the second locking recess may be provided on a second (opposite) lateral side of the security tag. Each locking recess may provide a release pathway for the respective retaining member and wherein the release pathways may only become available on release of the attachment means from the latch mechanism. Preferably the release pathway(s) are provided upon movement of a first part of the security tag away from the second part of the security tag.

The protective enclosure preferably comprises a rigid case.

Preferably the protective enclosure comprises a front side, a rear side, a first lateral side and a left lateral side. The protective enclosure may comprise a lower side. The protective enclosure may comprise a cover portion.

Preferably the cover portion provide an entry region to enable said item to be (slidably) received therein. The first retaining member and the second retaining member may be provide on opposing lateral sides of the entry region.

Preferably the security tag is preinstalled on said item and preferably is pre-secured (preinstalled) to a blister pack. Preferably said item with the security tag preinstalled is received in the protective enclosure and the protective enclosure is locked to the security tag. The subsequent release of the security tag from said item simultaneously unlocks the protective enclosure from the security tag.

The security tag may comprise a first part and a second part. Preferably the first part is movably connected to the second part. Preferably the first part is pivotally secured to the second part. The first part may comprise a first leaf and the second part may comprise a second leaf.

Preferably the first part and the second part are moved apart (opened) to enable a part of an item to be located therebetween. The first part and the second part may be closed to retain a part of the item therebetween.

Preferably the engagement of the attachment means with the latching mechanism secures (locks) the first part to the second part and may prevent relative movement therebetween. The disengagement of the attachment means with the latching mechanism may unsecure (unlock) the first part from the second part and may enable relative movement therebetween.

The latch mechanism may be provided on (mounted to) the first part. The attachment means may be provided on (mounted to) the second part.

The security tag may comprise an actuator to manually move the attachment means. The actuator may move the attachment means into engagement with the latch mechanism. The actuator may comprise a button and preferably comprises a push button.

The security tag may comprise a main body including a housing and an electronic article surveillance (EAS) sensor disposed in the housing. The EAS sensor is preferably an acousto-magnetic sensor.

The security tag may comprise means for attaching the main body to an article, at least a part of said attachment means being releasably engageable with the latch mechanism.

In preferred embodiments the attachment means comprises a pin including a shaft and a head, a part of the shaft being engageable with the latch mechanism. In some of these embodiments the first and second parts of the housing are on opposite sides of a plane and the plane extends substantially through a part of a packaging of an item and perpendicular to the shaft of the pin.

The first part of the housing preferably includes an (inner) contact surface which, in use, is in contact with or adjacent a part (first side) of said item, and the second part of the housing preferably includes an (inner) contact surface which, in use, is in contact with or adjacent a second part (second side) of said item.

In embodiments in which the attachment means comprises a pin, the pin is arranged to project through a part of the packaging of the item. Preferably the item comprises a blister pack and the pin may be arranged to project through the blister pack from a first side to a second side.

According to a second aspect of the present invention there is provided a protective enclosure for a security assembly
wherein the protective enclosure defines an internal space and comprises retaining means which is arranged to engage a part of a security tag in order to lock the protective enclosure to said security tag, and wherein, in a locked configuration, the protective enclosure at least partially encloses said item and inhibits access to said item.

The security tag may comprise:
a latch mechanism, and
attachment means,
the attachment means being arranged to attach the security tag to an item and wherein a part of the attachment means is releasably engageable with the latch mechanism.

Preferably disengagement of the attachment means from the latch mechanism permits release of the security tag from said item and simultaneously permits release of the protective enclosure from the security tag.

Preferably disengagement of the attachment means from the latch mechanism disengages the release mechanism from said item and simultaneously permits release of the protective enclosure from said security tag.

In preferred embodiments the protective enclosure defines an internal space and comprises retaining means arranged to engage a part of a security tag in order to lock the protective enclosure to said security tag and, in a locked configuration, the protective enclosure at least partially encloses an item within the internal space and inhibits access to the item.

Preferably the protective enclosure comprises a cover portion that provides an entry region to enable the item to be inserted into the internal space, and wherein, in the locked configuration, the security tag at least partially blocks the entry region to inhibit access to the item in the internal space.

According to a third aspect of the present invention there is provided a method of protecting an item comprising locking a protective enclosure to a security tag wherein the security tag comprising:
a latch mechanism, and
attachment means,
the attachment means being arranged to attach the security tag to said item and wherein a part of the attachment means is releasably engageable with the latch mechanism,
wherein the protective enclosure defines an internal space and comprises retaining means which is arranged to engage a part of the security tag in order to lock the protective enclosure to the security tag, and wherein, in a locked configuration, the protective enclosure at least partially encloses said item and inhibits access to said item, and
wherein disengagement of the attachment means from the latch mechanism permits release of the security tag from said item and simultaneously permits release of the protective enclosure from the security tag.

Preferably disengagement of the attachment means from the latch mechanism disengages the release mechanism from said item and simultaneously permits release of the protective enclosure from the security tag.

In preferred embodiments of a method of protecting an item with a protective enclosure and a security tag,
the security tag comprises a latch mechanism and attachment means arranged to attach the security tag to the item, a part of the attachment means being releasably engageable with the latch mechanism,
the protective enclosure defines an internal space and comprises retaining means,
and the method comprises engaging the retaining means with a part of the security tag to lock the protective enclosure to the security tag such that the protective enclosure at least partially encloses the item and inhibits access to said item, and
engagement of the retaining means with the security tag is such that disengagement of the attachment means from the latch mechanism simultaneously releases the security tag from the item and releases the protective enclosure from the security tag.

Preferably the protective enclosure further comprises a cover portion that provides an entry region to enable the item to be inserted into the internal space, and wherein, the method comprises engaging the retaining means with a part of the security tag such that a part of the security tag at least partially blocks the entry region to inhibit access to the item in the internal space.

### BRIEF DESCRIPTION OF THE DRAWINGS

The present invention will now be described, by way of example only, with reference to the accompanying drawings, in which:

FIG. 1 is a perspective view of a protective enclosure for use with a preferred embodiment of the security assembly;

FIG. 2 is a front view of a security tag for use in a preferred embodiment of a security assembly;

FIG. 3 is a side view of a security tag in a closed position for use in a preferred embodiment of a security assembly; and

FIG. 4 is a side view of a security tag in an open position for use in a preferred embodiment of a security assembly.

### DESCRIPTION OF THE PREFERRED EMBODIMENTS

This invention relates to security tags and in particular to electronic article surveillance (EAS) tags. The invention relates particularly to hard security tags that are removably attached to items in a retail environment. The preferred embodiments of the present invention provide a security assembly which combines a security tag 10 and a protective enclosure 12 or container/cassette for the item.

The present invention provides an improved security assembly particularly for use in retail environments in order to prevent and/or inhibit the unauthorised removal of an item from the retail outlet. The present invention is particularly for use in the protection of items retained within a blister pack, for example razor blades. Retail packs of razor blades are relatively expensive and small and thereby are at a particular risk of being stolen.

The security tag 10 includes a pin 20 which is arranged to project through the blister pack. The security tag 10 includes an electronic surveillance (EAS) sensor that generates detectable signals. A suitable EAS detector (not shown) is typically located at the exit of the retail store. If an item/article with a security tag 10 attached is removed from the store and, therefore, passes the detector, the detector detects the signals emitted by the EAS sensor and triggers an alarm.

To allow an article to leave the store without triggering the alarm, for example after purchasing the article, the security tag 10 is detached from the article. Typically the tag 10 is detached at the point of sale of the article by a suitable detacher system (not shown).

Whilst such tags 10 are effective there is still an opportunity for a person to attempt to physically remove the security tag 10 from the blister pack. In particular, certain stores may be at a particular risk and the present invention provides a secondary security system to further deter and inhibit the unauthorised removal of the article from the retail outlet.

The present invention provides a protective enclosure 12 which at least partially encapsulates the item and at least partially prevents access to the item. Accordingly, such a protective enclosure 12 restricts the access to the item such that an unauthorised user would not be able to directly (physically) rip the security tag from the blister pack. In some embodiments, the protective enclosure 12 surrounds the item from the front, rear, left side, right side, and underneath. Furthermore, the protective enclosure may have a top portion such that a user would not be able to physically directly touch the article at all. For display purposes, the protective enclosure 12 comprises a transparent material such that the item can still be clearly viewed at the point of sale. In some embodiments, the lid and/or one or more sides may not need to be transparent.

Protective enclosures for use in encapsulating items are known and may be provided with a dedicated EAS. These protective enclosures are located within the retail outlets and are used to encapsulate the relevant items by the staff within the retail outlet. However, it is advantageous to deliver items with pre-attached security tags 10 which thereby prevents the retail outlet having to attach these tags 10.

As mentioned above, there is a risk that these security tags 10 can be physically removed. If an item with such a pre-attached tag was decided to be at a particular risk, then the retail outlet may decide to place the item within a protective enclosure. However, this would then require the retail outlet to remove both the protective enclosure and the security tag 10 prior to the article leaving the store. This may require two release mechanisms and would be time consuming and particularly problematic at the point of sale where speed of service can be important.

Accordingly, the present invention provides a protective enclosure 12 which simply, quickly and easily secures to a pre-attached security tag 10 and wherein the release of the security tag latch mechanism releases both the security tag 10 from the article and also unlocks the protective enclosure 12 from around the article. Accordingly, the retail outlet may only need a single standard detachment system at the point of sale.

In addition, the retail outlet is able to receive articles on which security tags have been pre-secured such that the retail outlet will only be required to secure the protective enclosure 12 to the security tag 10.

The present invention provides a quick and easy clip mechanism in order to secure the protective enclosure 12 to the security tag. In particular, the protective enclosure 12 includes a first clip (retaining member) 40 and a second clip (retaining member) 42 which are arranged to engage in recesses 30, 32 provided by the security tag 10. In a preferred embodiment, the article together with the security tag 10 installed is slidably moved into the protective enclosure 12 and the clips 40, 42 include guide surfaces 41 which resiliently urge the clips 40, 42 apart to enable the security tag 10 to move between the clips 40, 42 until the clips 40, 42 are urged back towards each other and located within the respective recesses 30, 32.

As conventional arrangements, the security tag 10 is secured to the top of the item and provides a hanging aperture 14 or peg opening. At the point of sale, a rail projects through the hanging aperture 14 and the item is suspended therefrom. Accordingly, once the clips 40, 42 engage in the recesses 30, 32, the item is suspended and locates within the internal space (pocket) of the protective enclosure 12.

The clips 40, 42 have abutment surfaces 43 which means that the protective enclosure 12 cannot then be simply slidably removed from the security tag 10.

In one embodiment, the security tag 10 is provided with a first part 50 and a second part 52 which are pivotally connected to each other such that the two parts 50, 52 can pivot between a closed and secured position to an open and disengaged position.

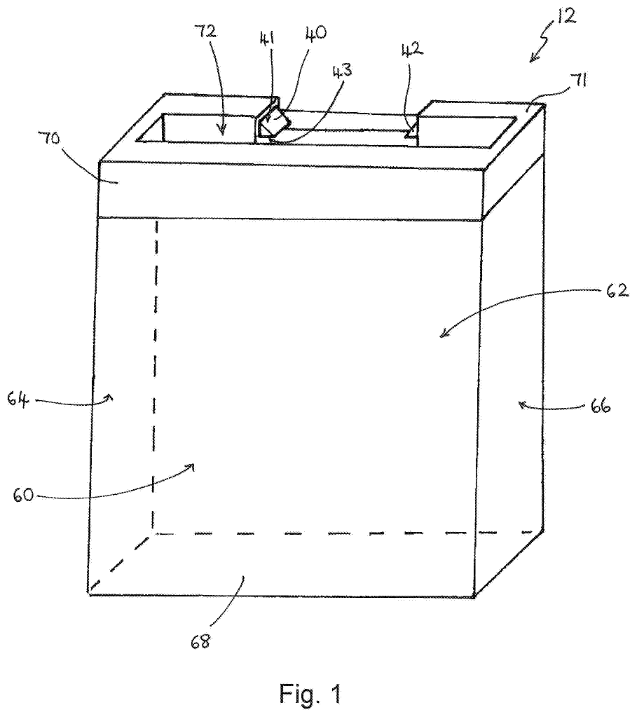

The preferred embodiment of the present invention will now be described in further detail with reference to FIGS. 1 to 4.

The protective enclosure 12 provides a generally transparent case with a front wall 60, rear wall 62, a left lateral side wall 64 and a right lateral side wall 66. In the preferred embodiment the protective case has a lower wall 68 to form an enclosure with an open end. The protective case further comprises a cover portion 70. The cover portion 70 defines an entry region or slot 72 through which an item may pass in order to locate within the protective case.

The cover portion 70 also provides the two retaining members 40, 42 and resilient mechanism (not shown) in the form of bias springs which urge the two retaining members 40, 42 towards each other. These springs are contained within a housing 71 of the cover portion 70 to prevent unauthorised tampering. It should be noted that the separation distance of the two retaining members is set to correspond with the lateral width of the security tag 10 but the cover portion 70 provides an entry slot 72 of a greater width to enable wider items to be contained therein.

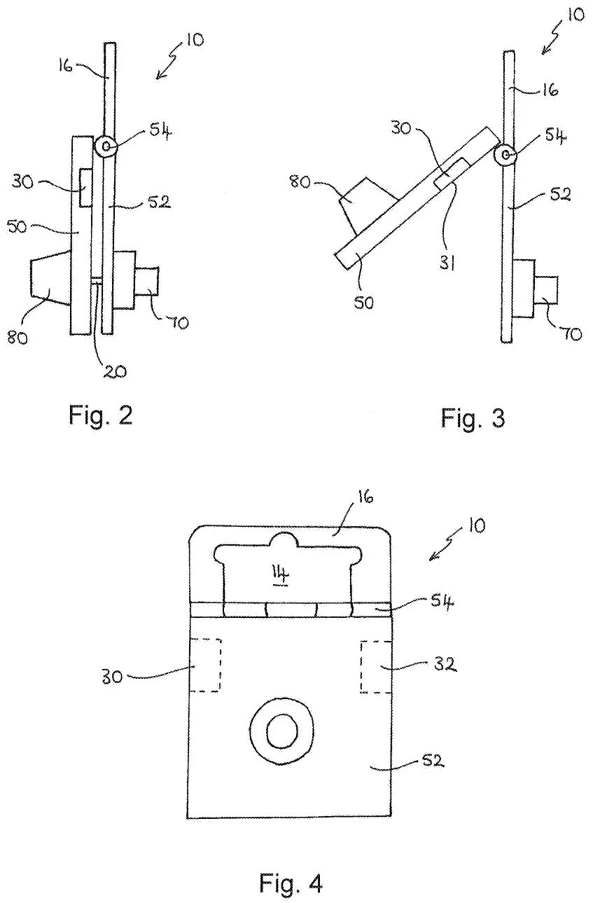

The security tag 10 comprises a first part 50 in the form of a first leaf and a second part 52 in the form of a second leaf. Both parts comprise rigid (plastic) planar members which are pivotally secured to each other. The security tag 10 includes a pivot arrangement 54 to enable the first part 50 and the second part 52 to move between a closed position (FIG. 2) and an open position (FIG. 3). The security tag 10 also comprises an upper part 16 through which the hanging aperture 14 is defined. This upper part 16 is independently attached to the pivot arrangement 54 such that the upper part 16, the first part 50 and the second part 52 are all independently movable.

The security tag 10 includes an attachment means mounted on the second part 52. The attachment means comprises a pin 20 which is axially movable by an actuator in the form of a push button 70. In use, the pin 20 is arranged to penetrate a blister pack. A proximal end of the pin 20 is engaged with the push button 70 whilst a distal end of the pin 20 is arranged to be releasably engaged with a latch mechanism 80. The push button arrangement incorporates a resilient mechanism in order to automatically withdraw the pin into the housing provided by the second part when the pin 20 is disengaged and free to move. This aims to prevent the end of the pin 20 from projecting outwardly and providing an injury risk.

The latch mechanism 80 is mounted on the first part 50 of the security tag 10 and provides an aligned aperture to receive the end of the pin 20. The latch mechanism utilise a conventional latching mechanism and is not described herein. However, by way of one example, the latching mechanism may include a (locking) ball bearing arrangement. For example, a plurality of locking balls may be provided with a spring in order to provide a wedging effect to grip the end of the needle/pin 20. The balls are metal and may also be magnetic. An opener may comprise a powerful magnet which opposes the force of the spring and reduces the wedging effect which enables the end of the needle 20 to be retracted from between the balls and thereby release the (distal) end of the needle 20. Accordingly, the latching mechanism 80 is arranged to grip and retain the end of the pin 20 and to only allow the release of the end of the pin 20 through the use of a dedicated release mechanism which may be provided at the sales counter.

The security tag 10 provides a first engagement recess 30 and a second engagement recess 32. Each engagement recess 30, 32 is arranged to receive and engage a respective retaining member 40, 42. The ends of the retaining members 40, 42 are shaped in order that the retaining members 40, 42 are automatically retracted as the ends of the retaining members 40, 42 abut the sides of the security tag 10 and move towards the recesses 30, 32.

Once the ends of the retaining members 40, 42 reach the recesses 30, 32 the urging mechanisms cause the retaining members 40, 42 to extend and for the ends of the retaining members 40, 42 to be engaged in the recesses 30, 32.

The ends of the retaining members 40, 42 are shaped like a saw tooth such that relative movement of the security tag 10 and the protective case 12 is prevented and the retaining members 40, 42 cannot be retracted to allow release from these recesses 30, 32. The separation distance of the two retaining members 40, 42 is arranged to correspond with the outer dimensions of the security tag 10 such that there is no significant exposed length of the retaining members 40, 42 and the retaining members 40, 42 are shrouded to prevent them from being gripped and moved apart.

In the closed configuration, the recesses 30, 32 have a contiguous enclosing wall such that the ends of the retaining members 40, 42 are enclosed and cannot be moved up, down, forwards or backwards. Furthermore, the retaining members 40, 42 cannot be retracted and therefore they are fully locked in positon. However, once the pin 20 is released from the latch mechanism 80 the two parts 50, 52 of the security tag 10 can be pivotally moved away from each other to an open position (see FIG. 3). In this position it can be seen that the recesses will now provide an open face 31 through which the retaining members 40, 42 can be disengaged from the security tag 10. Accordingly, only a single release mechanism is required and this simultaneously disengages the pin 20 from the latch mechanism 80 and subsequently enables the two parts 50, 52 to be moved to an open position at which the retaining members 40, 42 can be removed from the recesses 30, 32. The protective case 12 is immediately available for reuse in the store.

In use, the item is provided to the retail outlet with the security tag 10 preinstalled. If the retail outlet decides that added security is required then the protective enclosure 12 can be used. A user can then simply move the item through the slot 72 provided in the protective enclosure 12. The security tag 10 is positioned such that the ends of the retaining members abut and will move relatively up the sides of the security tag 10 until they extend and project into the recesses 30, 32. In this configuration, the item is protected by both the security tag 10 and has the additional security provided by the protective case 12 which may prevent the blister pack being ripped, split or otherwise destroyed in order to enable the unauthorised physical removal of the security tag 10.

At the sales counter, a single standard release mechanism may be provided which releases the pin 20 from the latch mechanism 80. This enables the two parts 50, 52 of the security tag 10 to be pivoted away from each other and this thereby releases the protective case 12 from the security tag 10. Accordingly only a single operation at a point of sale is required to remove both the protective case 12 and the security tag 10 from the item.

The present invention therefore provides an improved security tag assembly that deters or prevents theft of an item from a retail environment and is easy to remove at a point of sale. The present invention also has the advantage that the security tag can be applied to the item at the point of shipment, and then the protective enclosure can be applied to the item in the retail store if it is decided that an extra level of security is required.

1. An assembly comprising:
a security tag including a latch mechanism and an attachment mechanism, the attachment mechanism being arranged to attach the security tag to an item and wherein a part of the attachment mechanism is releasably engageable with the latch mechanism; and
a protective enclosure comprising a retaining member arranged to engage a part of the security tag in order to lock the protective enclosure to the security tag and an internal space for receiving at least a part of said item,
wherein, in a locked configuration, the protective enclosure at least partially encloses said item and inhibits access to said item, and wherein disengagement of the attachment mechanism from the latch mechanism simultaneously permits release of the security tag from said item and permits release of the protective enclosure from the security tag.

2. An assembly as claimed in claim 1 wherein the protective enclosure comprises a first retaining member and a second retaining member.

3. An assembly as claimed in claim 2 wherein the first retaining member and the second retaining member are opposed and spaced apart, and the first retaining member and the second retaining member are biased towards each other.

4. An assembly as claimed in claim 2 wherein the first retaining member and the second retaining member are configured to enable lateral sides of the security tag to slidably move therebetween as the security tag moves from an unlocked position to the locked position.

5. An assembly as claimed in claim 4 wherein the first retaining member and the second retaining member are urged apart by the lateral sides of the security tag as the security tag moves towards the locked position, and in the locked position the retaining members cannot be moved apart by relative movement of the security tag.

6. An assembly as claimed in claim 1 in which the security tag includes a first locking recess for the first retaining member and a second locking recess for the second retaining member.

7. An assembly as claimed in claim 6, wherein the first locking recess is provided on a first lateral side of the security tag and the second locking recess is provided on a second lateral side of the security tag.

8. An assembly as claimed in claim 6, wherein each locking recess provides a release pathway for the respective retaining member and wherein the release pathways may only become available on release of the attachment mechanism from the latch mechanism and movement of a first part of the security tag away from a second part of the security tag.

9. An assembly as claimed in claim 2, wherein the protective enclosure comprises a rigid case.

10. An assembly as claimed in claim 9, wherein the protective enclosure comprises a cover portion that provides an entry region to enable said item to be inserted into the protective enclosure, and wherein the first retaining member and the second retaining member are provided on opposing lateral sides of the entry region.

11. An assembly as claimed in claim 1, in which the security tag comprises a first part and a second part, the first part being movably connected to the second part and the first part and the second part are moved apart to enable apart of an item to be located therebetween, and the first part and the second art are moved towards each other to retain a part of the item therebetween.

12. (canceled)

13. An assembly as claimed in claim 11, wherein engagement of the attachment mechanism with the latching mechanism locks the first part to the second part and prevents relative movement therebetween.

14. An assembly as claimed in claim 11, wherein the latch mechanism is provided on the first part and the attachment mechanism is provided on the second part.

15. An assembly as claimed in claim 1, wherein the security tag comprises an actuator to manually move the attachment mechanism into engagement with the latch mechanism.

16. (canceled)

17. An assembly as claimed in claim 1, in which the attachment mechanism comprises a pin, a part of a shaft of the pin being engageable with the latch mechanism.

18. An assembly as claimed in claim 1, in which the security tag comprises electronic article surveillance (EAS) sensor.

19. A protective enclosure for a security assembly, the protective enclosure defining an internal space and comprising retaining means arranged to engage a part of a security tag in order to lock the protective enclosure to said security tag, and wherein, in a locked configuration, the protective enclosure at least partially encloses an item within the internal space and inhibits access to said item.

20. A protective enclosure as claimed in claim 19 further comprising a cover portion that provides an entry region to enable said item to be inserted into the internal space, and wherein, in the locked configuration, the security tag at least partially blocks the entry region to inhibit access to the item in the internal space.

21. A method of protecting an item with a protective enclosure and a security tag,
wherein the security tag comprises a latch mechanism and an attachment mechanism arranged to attach the security tag to said item, a part of the attachment mechanism being releasably engageable with the latch mechanism,
wherein the protective enclosure defines an internal space and comprises a retaining member,
and wherein the method comprises engaging the retaining member with a part of the security tag to lock the protective enclosure to the security tag such that the protective enclosure at least partially encloses said item and inhibits access to said item, and
wherein engagement of the retaining member with the security tag is such that disengagement of the attachment mechanism from the latch mechanism simultaneously releases the security tag from said item and releases the protective enclosure from the security tag.

22. A method as claimed in claim 21, wherein the protective enclosure further comprises a cover portion that provides an entry region to enable said item to be inserted into the internal space, and wherein, the method comprises engaging the retaining member with a part of the security tag such that a part of the security tag at least partially blocks the entry region to inhibit access to the item in the internal space.
